(19) United States
(12) Patent Application Publication
(10) Pub. No.: US 2023/0023556 A1
(43) Pub. Date: Jan. 26, 2023

(54) SYSTEM AND METHOD OF PDCCH SKIPPING AND RANDOM ACCESS

(71) Applicant: Samsung Electronics Co., Ltd., Suwon-si (KR)

(72) Inventor: Anil AGIWAL, Suwon-si (KR)

(21) Appl. No.: 17/869,181

(22) Filed: Jul. 20, 2022

(30) Foreign Application Priority Data
Jul. 21, 2021 (KR) 10-2021-0095553

(51) Int. Cl. H04W 74/08; H04W 74/00

(52) U.S. Cl. CPC H04W 74/0833; H04W 74/006

(57) ABSTRACT

The disclosure relates to a fifth generation (5G) or sixth generation (6G) communication system for supporting a higher data transmission rate. The disclosure relates to a wireless communication system. An apparatus, a method and a system for physical downlink control channel (PDCCH) monitoring are provided.

### CROSS-REFERENCE TO RELATED APPLICATION(S)

This application is based on and claims priority under 35 U.S.C. § 119(a) of a Korean patent application number 10-2021-0095553, filed on Jul. 21, 2022, in the Korean Intellectual Property Office, the disclosure of which is incorporated by reference herein in its entirety.

### BACKGROUND

### 1. Field

The disclosure relates to a wireless communication system. More particularly, the disclosure relates to an apparatus, a method and a system for physical downlink control channel (PDCCH) monitoring.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LPDC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is the UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on the UE's positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of a UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for PDCCH skipping associated with a random access procedure.

Another aspect of the disclosure is to provide a method and an apparatus for controlling and processing a PDCCH skipping duration in case that a PDCCH skipping is received by a terminal, a random access procedure is triggered, Msg1/MsgA is transmitted, and at least a part of RAR/MsgB reception window is overlapped with at least a part of the PDCCH skipping duration.

Another aspect of the disclosure is to provide a method and an apparatus for controlling and processing a PDCCH skipping duration in case that a PDCCH skipping is received by a terminal, a random access procedure is triggered, Msg1/MsgA is transmitted, and at least a part of a contention resolution timer duration is overlapped with at least a part of the PDCCH skipping duration.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method comprises receiving, from a base station, an indication for indicating a skipping of monitoring a physical downlink control channel (PDCCH), transmitting, to the base station, a random access preamble, and in case that at least a part of a duration of the skipping of monitoring the PDCCH overlaps with at least a part of a duration for receiving a random access response corresponding to the random access preamble, ignoring PDCCH skipping during the at least the part of the duration of the skipping of monitoring the PDCCH.

In an embodiment, the ignoring the PDCCH is performed on a special cell (SpCell).

In an embodiment, the indication for indicating the skipping of monitoring the PDCCH is received from the base station for a special cell (SpCell).

In an embodiment, the duration for receiving the random access response corresponding to the random access preamble comprises a random access response window.

In an embodiment, the method further comprises in case that at least a part of the duration of the skipping of monitoring the PDCCH overlaps with at least a part of a duration associated with a contention resolution timer, ignoring PDCCH skipping during the at least the part of the duration of the skipping of monitoring the PDCCH.

In an embodiment, the method further comprises receiving, from the base station, a random access response, transmitting, to the base station, a message 3 as a response to the random access response, and starting the contention resolution timer.

In an embodiment, the indication is received in downlink control information.

In an embodiment, the method further comprises receiving, from the base station, information on a duration of the skipping of monitoring the PDCCH.

In accordance with another aspect of the disclosure, a terminal in a wireless communication system is provided. The terminal comprises a transceiver, and a controller coupled with the transceiver and configured to receive, from a base station, an indication for indicating a skipping of monitoring a physical downlink control channel (PDCCH), transmit, to the base station, a random access preamble, and in case that at least a part of a duration of the skipping of monitoring the PDCCH overlaps with at least a part of a duration for receiving a random access response corresponding to the random access preamble, ignoring PDCCH skipping during the at least the part of the duration of the skipping of monitoring the PDCCH.

According to an embodiment of the disclosure, a method and an apparatus for PDCCH skipping associated with a random access procedure are proposed.

According to an embodiment of the disclosure, in case that a PDCCH skipping is received by a terminal, a random access procedure is triggered, Msg1/MsgA is transmitted, and at least a part of RAR/MsgB reception window is overlapped with at least a part of the PDCCH skipping duration, a method and an apparatus for controlling and processing a PDCCH skipping duration are proposed.

According to an embodiment of the disclosure, in case that a PDCCH skipping is received by a terminal, a random access procedure is triggered, Msg1/MsgA is transmitted, and at least a part of a contention resolution timer duration is overlapped with at least a part of the PDCCH skipping duration, a method and an apparatus for controlling and processing a PDCCH skipping duration are proposed.

Other aspects, advantages, and salient features of the disclosure will become apparent to those skilled in the art from the the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an example illustration of random access (RA) type selection according to an embodiment of the disclosure;

FIG. 2 is an example illustration of RA type selection according to an embodiment of the disclosure;

FIG. 3 discloses an example of an Msg4 reception associated with a PDCCH skipping according to an embodiment of the disclosure;

FIG. 4 discloses an embodiment of the disclosure for a random access procedure associated with an PDCCH skipping according to an embodiment of the disclosure;

FIG. 5 discloses another embodiment of the disclosure for a random access procedure associated with an PDCCH skipping according to an embodiment of the disclosure;

FIG. 6 discloses another embodiment of the disclosure for a random access procedure associated with an PDCCH skipping according to an embodiment of the disclosure;

FIG. 7 is a diagram illustrating a configuration of a terminal according to an embodiment of the disclosure; and

FIG. 8 is a diagram illustrating a configuration of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may also refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

A “base station (BS)” is an entity communicating with a user equipment (UE) and may be referred to as a BS, a base transceiver station (BTS), a radio access network (RAN), a node B (NB), an evolved NB (eNB), an access point (AP), a fifth generation (5G) NB (5GNB), or a next generation NB (gNB).

A “user equipment (UE)” is an entity communicating with a BS and may be referred to as a UE, a device, a mobile station (MS), a mobile equipment (ME), or a terminal.

To meet the demand for wireless data traffic having increased since deployment of fourth generation (4G) communication systems, efforts have been made to develop an improved 5G or pre-5G communication system. Therefore, the 5G or pre-5G communication system is also called a ‘Beyond 4G Network’ or a ‘Post long-term evolution (LTE) System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid frequency shift keying (FSK) and quadrature amplitude modulation (QAM) (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analysing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

Carrier aggregation (CA)/Multi-connectivity in fifth generation wireless communication system: The fifth generation wireless communication system, supports standalone mode of operation as well dual connectivity (DC). In DC a multiple Rx/Tx UE may be configured to utilise resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-radio access technology (RAT) Dual Connectivity (MR-DC) operation whereby a UE in RRC_CONNECTED is configured to utilise radio resources provided by two distinct schedulers, located in two different nodes connected via a non-ideal backhaul and providing either E-UTRA (i.e., if the node is an ng-eNB) or NR access (i.e., if the node is a gNB). In NR for a UE in RRC_CONNECTED not configured with CA/DC there is only one serving cell comprising of the primary cell. For a UE in RRC_CONNECTED configured with CA/DC the term ‘serving cells’ is used to denote the set of cells comprising of the Special Cell(s) (SpCell(s)) and all secondary cells. In NR the term Master Cell Group (MCG) refers to a group of serving cells associated with the Master Node, comprising of the primary cell (PS) and optionally one or more secondary cells (SCells). In NR the term Secondary Cell Group (SCG) refers to a group of serving cells associated with the Secondary Node, comprising of the PSCell (primary secondary cell) and optionally one or more SCells. In NR PCell refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (i.e., Special Cell) refers to the PCell of the MCG or the PSCell of the SCG, otherwise the term Special Cell refers to the PCell.

Random access in fifth generation wireless communication system: In the 5G wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC_CONNECTED state. Several types of random access procedure is supported.

Contention based random access (CBRA): This is also referred as 4 step CBRA. In this type of random access, the UE first transmits Random Access preamble (also referred as Msg1) and then waits for Random access response (RAR) in the RAR window. RAR is also referred as Msg2. Next generation node B (gNB) transmits the RAR on physical downlink shared channel (PDSCH). PDCCH scheduling the PDSCH carrying RAR is addressed to RA-radio network temporary identifier (RA-RNTI). RA-RNTI identifies the time-frequency resource (also referred as physical RA channel (PRACH) occasion or PRACH transmission (TX) occasion or RA channel (RACH) occasion) in which RA preamble was detected by the gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier. Several RARs for various Random access preambles detected by the gNB can be multiplexed in the same RAR media access control (MAC) protocol data unit (PDU) by the gNB. An RAR in MAC PDU corresponds to the UE's RA preamble transmission if the RAR includes an RA preamble identifier (RAPID) of RA preamble transmitted by the UE. If the RAR corresponding to its RA preamble transmission is not received during the RAR window and the UE has not yet transmitted the RA preamble for a configurable (configured by the gNB in RACH configuration) number of times, the UE goes back to first step, i.e., select random access resource (preamble/RACH occasion) and transmits the RA preamble. A backoff may be applied before going back to first step.

If the RAR corresponding to its RA preamble transmission is received the UE transmits message 3 (Msg3) in UL grant received in RAR. Msg3 includes message such as RRC connection request, RRC connection re-establishment request, RRC handover confirm, scheduling request, SI request etc. It may include the UE identity (i.e., cell-radio network temporary identifier (C-RNTI) or system architecture evolution (SAE)-temporary mobile subscriber identity (S-TMSI) or a random number). After transmitting the Msg3, the UE starts a contention resolution timer. While the contention resolution timer is running, if the UE receives a physical downlink control channel (PDCCH) addressed to C-RNTI included in Msg3, contention resolution is considered successful, contention resolution timer is stopped and the RA procedure is completed. While the contention resolution timer is running, if the UE receives contention resolution MAC control element (CE) including the UE's contention resolution identity (first X bits of common control channel (CCCH) service data unit (SDU) transmitted in Msg3), contention resolution is considered successful, contention resolution timer is stopped and RA procedure is completed. If the contention resolution timer expires and the UE has not yet transmitted the RA preamble for a configurable number of times, the UE goes back to first step i.e., select random access resource (preamble/RACH occasion) and transmits the RA preamble. A backoff may be applied before going back to first step.

Contention free random access (CFRA): This is also referred as legacy CFRA or 4 step CFRA. CFRA procedure is used for scenarios such as handover where low latency is required, timing advance establishment for secondary cell (Scell), etc. Evolved node B (eNB) assigns to the UE dedicated Random access preamble. The UE transmits the dedicated RA preamble. ENB transmits the RAR on PDSCH addressed to RA-RNTI. RAR conveys RA preamble identifier and timing alignment information. RAR may also include UL grant. RAR is transmitted in RAR window similar to contention based RA (CBRA) procedure. CFRA is considered successfully completed after receiving the RAR including RA preamble identifier (RAPID) of RA preamble transmitted by the UE. In case RA is initiated for beam failure recovery, CFRA is considered successfully completed if PDCCH addressed to C-RNTI is received in search space for beam failure recovery. If the RAR window expires and RA is not successfully completed and the UE has not yet transmitted the RA preamble for a configurable (configured by the gNB in RACH configuration) number of times, the UE retransmits the RA preamble.

For certain events such has handover and beam failure recovery if dedicated preamble(s) are assigned to the UE, during first step of random access i.e., during random access resource selection for Msg1 transmission the UE determines whether to transmit dedicated preamble or non-dedicated preamble. Dedicated preambles is typically provided for a subset of SSBs/CSI RSs (synchronization signal blocks/channel state information reference signals). If there is no SSB/CSI RS having DL (downlink) RSRP (reference-signal received power) above a threshold amongst the SSBs/CSI RSs for which contention free random access resources (i.e., dedicated preambles/ROs) are provided by the gNB, the UE select non dedicated preamble. Otherwise the UE select dedicated preamble. So during the RA procedure, one random access attempt can be CFRA while other random access attempt can be CBRA.

2 step contention based random access (2 step CBRA): In the first step, the UE transmits random access preamble on PRACH and a payload (i.e., MAC PDU) on PUSCH. The random access preamble and payload transmission is also referred as MsgA. In the second step, after MsgA transmission, the UE monitors for a response from the network (i.e., the gNB) within a configured window. The response is also referred as MsgB. Next generation node B (gNB) transmits the MsgB on physical downlink shared channel (PDSCH). PDCCH scheduling the PDSCH carrying MsgB is addressed to MsgB-radio network temporary identifier (MSGB-RNTI). MSGB-RNTI identifies the time-frequency resource (also referred as physical RA channel (PRACH) occasion or PRACH transmission (TX) occasion or RA channel (RACH) occasion) in which RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where the UE has transmitted Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

If common control channel (CCCH) service data unit (SDU) was transmitted in MsgA payload, the UE performs contention resolution using the contention resolution information in MsgB. The contention resolution is successful if the contention resolution identity received in MsgB matches first 48 bits of CCCH SDU transmitted in MsgA. If C-RNTI was transmitted in MsgA payload, the contention resolution is successful if the UE receives the PDCCH addressed to C-RNTI. If contention resolution is successful, random access procedure is considered successfully completed. Instead of contention resolution information corresponding to the transmitted MsgA, MsgB may include a fallback information corresponding to the random access preamble transmitted in MsgA. If the fallback information is received, the UE transmits Msg3 and performs contention resolution using Msg4 as in CBRA procedure. If contention resolution is successful, random access procedure is considered successfully completed. If contention resolution fails upon fallback (i.e., upon transmitting Msg3), UE retransmits MsgA. If configured window in which the UE monitor network response after transmitting MsgA expires and the UE has not received MsgB including contention resolution information or fallback information as explained above, the UE retransmits MsgA. If the random access procedure is not successfully completed even after transmitting the msgA configurable number of times, the UE fallbacks to 4 step RACH procedure i.e., the UE only transmits the PRACH preamble.

MsgA payload may include one or more of common control channel (CCCH) service data unit (SDU), dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. MsgA may include the UE ID (e.g. random ID, S-TMSI, C-RNTI, resume ID, etc.) along with preamble in first step. The UE ID may be included in the MAC PDU of the MsgA. The UE ID such as C-RNTI may be carried in MAC CE wherein MAC CE is included in MAC PDU. Other the UE IDs (such random ID, S-TMSI, C-RNTI, resume ID, etc.) may be carried in CCCH SDU. The UE ID can be one of random ID, S-TMSI, C-RNTI, resume ID, international mobile subscriber identity (IMSI), idle mode ID, inactive mode ID, etc. The UE ID can be different in different scenarios in which UE performs the RA procedure. When the UE performs RA after power on (before it is attached to the network), then the UE ID is the random ID. When the UE perform RA in IDLE state after it is attached to network, the UE ID is S-TMSI. If the UE has an assigned C-RNTI (e.g. in connected state), the UE ID is C-RNTI. In case the UE is in INACTIVE state, the UE ID is resume ID. In addition to the UE ID, some addition ctrl information can be sent in MsgA. The control information may be included in the MAC PDU of the MsgA. The control information may include one or more of connection request indication, connection resume request indication, SI request indication, buffer status indication, beam information (e.g. one or more DL TX beam ID(s) or SSB ID(s)), beam failure recovery indication/information, data indicator, cell/BS/TRP switching indication, connection re-establishment indication, reconfiguration complete or handover complete message, etc.

2 step contention free random access (2 step CFRA): In this case the gNB assigns to the UE dedicated Random access preamble (s) and PUSCH resource(s) for MsgA transmission. RO(s) to be used for preamble transmission may also be indicated. In the first step, the UE transmits random access preamble on PRACH and a payload on PUSCH using the contention free random access resources (i.e., dedicated preamble/PUSCH resource/RO). In the second step, after MsgA transmission, the UE monitors for a response from the network (i.e., the gNB) within a configured window. The response is also referred as MsgB.

Next generation node B (gNB) transmits the MsgB on physical downlink shared channel (PDSCH). PDCCH scheduling the PDSCH carrying MsgB is addressed to MsgB-radio network temporary identifier (MSGB-RNTI). MSGB-RNTI identifies the time-frequency resource (also referred as physical RA channel (PRACH) occasion or PRACH transmission (TX) occasion or RA channel (RACH) occasion) in which RA preamble was detected by the gNB. The MSGB -RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where the UE has transmitted Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

If the UE receives PDCCH addressed to C-RNTI, random access procedure is considered successfully completed. If the UE receives fallback information corresponding to its transmitted preamble, random access procedure is considered successfully completed.

For certain events such has handover and beam failure recovery if dedicated preamble(s) and PUSCH resource(s) are assigned to the UE, during first step of random access i.e., during random access resource selection for MsgA transmission the UE determines whether to transmit dedicated preamble or non-dedicated preamble. Dedicated preambles is typically provided for a subset of SSBs/CSI RSs. If there is no SSB/CSI RS having DL RSRP above a threshold amongst the SSBs/CSI RSs for which contention free random access resources (i.e., dedicated preambles/ROs/PUSCH resources) are provided by the gNB, the UE select non dedicated preamble. Otherwise, the UE select dedicated preamble. So during the RA procedure, one random access attempt can be 2 step CFRA while other random access attempt can be 2 step CBRA.

Upon initiation of random access procedure, the UE first selects the carrier (SUL or NUL). If the carrier to use for the Random Access procedure is explicitly signalled by the gNB, the UE select the signalled carrier for performing Random Access procedure. If the carrier to use for the Random Access procedure is not explicitly signalled by the gNB; and if the Serving Cell for the Random Access procedure is configured with supplementary uplink and if the RSRP of the downlink pathloss reference is less than rsrp-ThresholdSSB-SUL: the UE select the SUL carrier for performing Random Access procedure. Otherwise, the UE select the NUL carrier for performing Random Access procedure. Upon selecting the UL carrier, the UE determines the UL and DL BWP for random access procedure as specified in section 5.15 of TS 38.321. The UE then determines whether to perform 2 step or 4 step RACH for this random access procedure.
If this random access procedure is initiated by PDCCH order and if the ra-PreambleIndex explicitly provided by PDCCH is not 0b000000, the UE selects 4 step RACH.
else if 2 step contention free random access resources are signaled by the gNB for this random access procedure, the UE selects 2 step RACH.
else if 4 step contention free random access resources are signaled by the gNB for this random access procedure, the UE selects 4 step RACH.
else if the UL BWP selected for this random access procedure is configured with only 2 step RACH resources, the UE selects 2 step RACH.
else if the UL BWP selected for this random access procedure is configured with only 4 step RACH resources, the UE selects 4 step RACH.
else if the UL BWP selected for this random access procedure is configured with both 2 step and 4 step RACH resources,
if RSRP of the downlink pathloss reference is below a configured threshold, UE selects 4 step RACH. Otherwise, the UE selects 2 step RACH.

BWP operation in fifth generation wireless communication system: In fifth generation wireless communication system bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a bandwidth part (BWP). BA is achieved by configuring radio resource control (RRC) connected UE with BWP(s) and telling the UE which of the configured BWPs is currently the active one. When BA is configured, the UE only has to monitor PDCCH on the one active BWP i.e., it does not have to monitor PDCCH on the entire DL frequency of the serving cell. In RRC connected state, the UE is configured with one or more DL and UL BWPs, for each configured Serving Cell (i.e., PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

In the fifth generation wireless communication system, RRC can be in one of the following states: RRC_IDLE, RRC_INACTIVE, and RRC_CONNECTED. A UE is either in RRC_CONNECTED state or in RRC_INACTIVE state when an RRC connection has been established. If this is not the case, i.e., no RRC connection is established, the UE is in RRC_IDLE state. The RRC states can further be characterized as follows:

In the RRC_IDLE, a UE specific discontinuous (DRX) may be configured by upper layers. The UE monitors Short Messages transmitted with paging RNTI (P-RNTI) over DCI (downlink control information); monitors a Paging channel for CN paging using 5G-S-temporary mobile subscriber identity (5G-S-TMSI); performs neighboring cell measurements and cell (re-)selection; acquires system information and can send SI (system information) request (if configured); performs logging of available measurements together with location and time for logged measurement configured UEs.

In RRC_INACTIVE, a UE specific DRX may be configured by upper layers or by RRC layer; the UE stores the UE Inactive AS (access stratum) context; a RAN-based notification area is configured by RRC layer. The UE monitors Short Messages transmitted with P-RNTI over DCI; monitors a Paging channel for CN paging using 5G-S-TMSI and RAN paging using fulll-RNTI; performs neighbouring cell measurements and cell (re-)selection; performs RAN-based notification area updates periodically and when moving outside the configured RAN-based notification area; acquires system information and can send SI request (if configured); performs logging of available measurements together with location and time for logged measurement configured UEs.

In the RRC_CONNECTED, the UE stores the AS context and transfer of unicast data to/from the UE takes place. The UE monitors Short Messages transmitted with P-RNTI over DCI, if configured; monitors control channels associated with the shared data channel to determine if data is scheduled for it; provides channel quality and feedback information; performs neighbouring cell measurements and measurement reporting; acquires system information.

PDCCH in fifth generation wireless communication system: In the fifth generation wireless communication system, Physical Downlink Control Channel (PDCCH) is used to schedule DL transmissions on PDSCH and UL transmissions on PUSCH, where the Downlink Control Information (DCI) on PDCCH includes: Downlink assignments containing at least modulation and coding format, resource allocation, and hybrid-ARQ (hybrid automatic repeat request) information related to DL-SCH; Uplink scheduling grants containing at least modulation and coding format, resource allocation, and hybrid-ARQ information related to UL-SCH. In addition to scheduling, PDCCH can be used to for: Activation and deactivation of configured PUSCH transmission with configured grant; Activation and deactivation of PDSCH semi-persistent transmission; Notifying one or more UEs of the slot format; Notifying one or more UEs of the PRB(s) and OFDM symbol(s) where the UE may assume no transmission is intended for the UE; Transmission of TPC commands for PUCCH and PUSCH; Transmission of one or more TPC commands for SRS transmissions by one or more UEs; Switching a UE's active bandwidth part; Initiating a random access procedure. A UE monitors a set of PDCCH candidates in the configured monitoring occasions in one or more configured control resource sets (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In fifth generation wireless communication system, a list of search space configurations is signaled by the gNB for each configured BWP of serving cell wherein each search configuration is uniquely identified by a search space identifier. Search space identifier is unique amongst the BWPs of a serving cell. Identifier of search space configuration to be used for specific purpose such as paging reception, SI reception, random access response reception is explicitly signaled by the gNB for each configured BWP. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below:

(y*(number of slots in a radio frame)+x−Monitoring-offset-PDCCH-slot) mod (Monitoring-periodicity-PDCCH-slot)=0;

The starting symbol of a PDCCH monitoring occasion in each slot having PDCCH monitoring occasion is given by Monitoring-symbols-PDCCH-within-slot. The length (in symbols) of a PDCCH monitoring occasion is given in the CORESET associated with the search space. Search space configuration includes the identifier of CORESET configuration associated with it. A list of CORESET configurations are signaled by the gNB for each configured BWP of serving cell wherein each CORESET configuration is uniquely identified by an CORESET identifier. CORESET identifier is unique amongst the BWPs of a serving cell. Note that each radio frame is of 10ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS (subcarrier spacing) is pre-defined in NR. Each CORESET configuration is associated with a list of Transmission configuration indicator (TCI) states. One DL RS ID (SSB or CSI RS) is configured per TCI state. The list of TCI states corresponding to a CORESET configuration is signaled by the gNB via RRC signaling. One of the TCI state in TCI state list is activated and indicated to the UE by the gNB. TCI state indicates the DL TX beam (DL TX beam is QCLed with SSB/CSI RS of TCI state) used by the gNB for transmission of PDCCH in the PDCCH monitoring occasions of a search space.

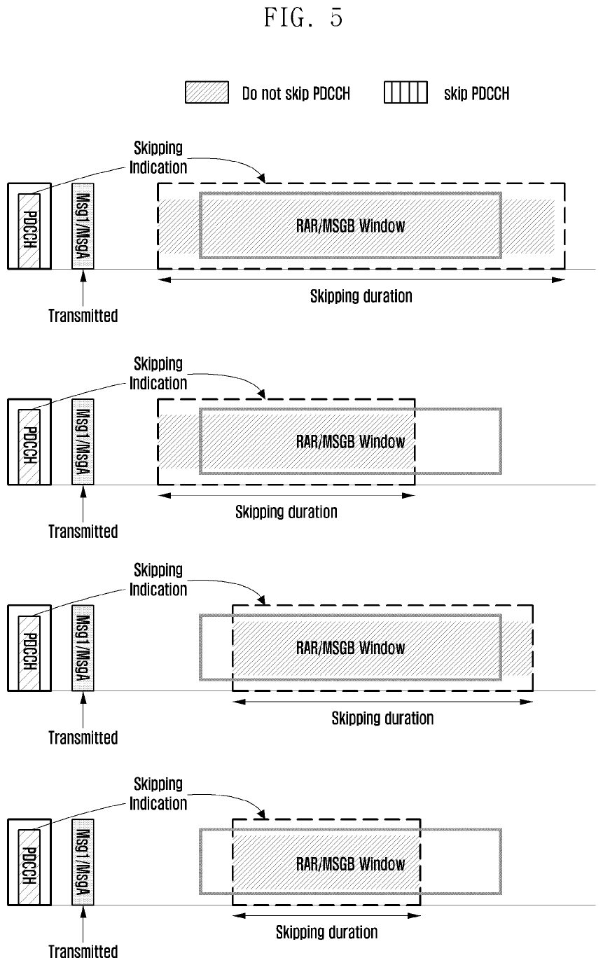

In 5G wireless communication system, the PDCCH monitoring activity of the UE in RRC connected mode is governed by DRX. When DRX is configured, the UE does not have to continuously monitor PDCCH. DRX is characterized by the following:
on-duration: duration that the UE waits for, after waking up, to receive PDCCHs. If the UE successfully decodes a PDCCH, the UE stays awake and starts the inactivity timer;
inactivity-timer: duration that the UE waits to successfully decode a PDCCH, from the last successful decoding of a PDCCH, failing which it can go back to sleep. The UE shall restart the inactivity timer following a single successful decoding of a PDCCH for a first transmission only (i.e., not for retransmissions);
retransmission-timer: duration until a retransmission can be expected;
cycle: specifies the periodic repetition of the on-duration followed by a possible period of inactivity (see FIG. 5 below);
active-time: total duration that the UE monitors PDCCH. This includes the “on-duration” of the DRX cycle, the time the UE is performing continuous reception while the inactivity timer has not expired, and the time when the UE is performing continuous reception while waiting for a retransmission opportunity.

In the RRC_CONNECTED serving cells of a MAC entity may be configured by RRC in two DRX groups with separate DRX parameters. Note that MAC entity is per cell group (CG). When RRC does not configure a secondary DRX group in a CG, there is only one DRX group in that CG and all Serving Cells of that belong to that one DRX group. When two DRX groups are configured in a CG, each Serving Cell of CG is uniquely assigned to either of the two groups. DRX Parameters are categorised into group specific parameters and common parameters. The group specific parameters consist of drx-onDurationTimer and drx-InactivityTimer. The common parameters consist of drx-SlotOffset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, and drx-HARQ-RTT-TimerUL.

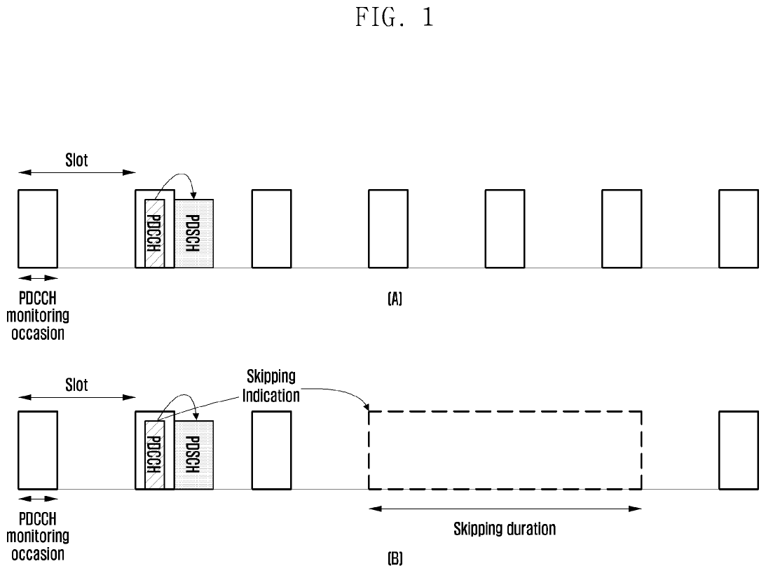

FIG. 1 is an example illustration of PDCCH skipping according to an embodiment of the disclosure.

Referring to FIG. 1, there have been various studies on optimising PDCCH monitoring in 5G communication system recently. PDCCH skipping as illustrated in FIG. 1 below can be applied by the UE for PDCCH monitoring in RRC_CONNECTED state. Part (A) of FIG. 1 illustrates normal PDCCH monitoring where the UE monitors all the configured PDCCH monitoring occasions. Part (B) of FIG. 1 illustrates PDCCH skipping indicated by scheduling DCI. The scheduling DCI is the DCI which indicates scheduled DL or UL resources. Skipping duration can be indicated by RRC message or can be indicated by DCI or can be pre-defined. Upon receiving PDCCH skipping indication, the UE skips PDCCH monitoring during the skipping duration.

Search space set group (SSSG) switching for PDCCH skipping can also be applied by the UE for PDCCH monitoring in RRC_CONNECTED state. The UE can be switched to an ‘empty’ SSSG i.e., no SS set(s) is configured for this SSSG. So, the UE does not monitoring PDCCH when the UE switches to it.

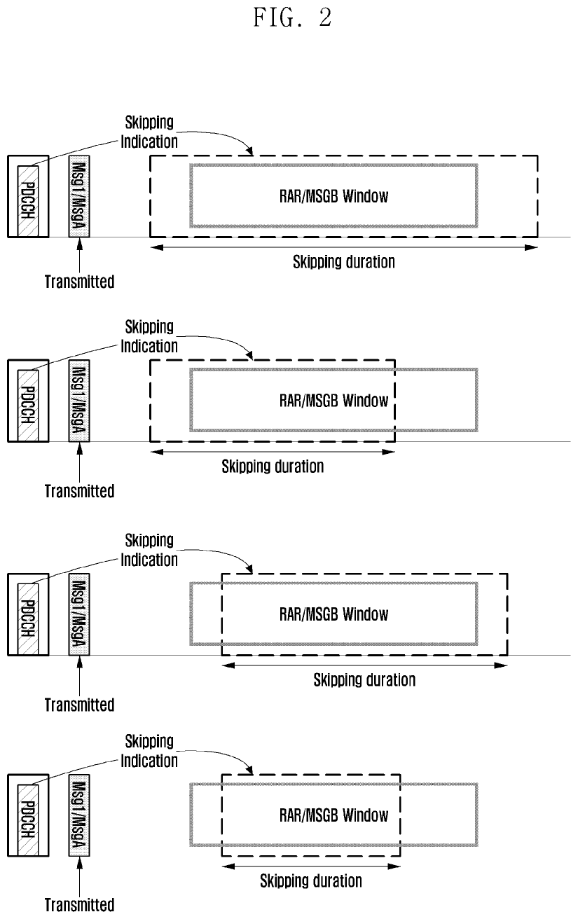

FIG. 2 discloses an example of an RAR/MsgB reception associated with a PDCCH skipping according to an embodiment of the disclosure.

Referring to FIG. 2, if the UE has received PDCCH skipping indication and RA is triggered and Msg1/MsgA is transmitted, RAR/MsgB reception can be missed or delayed due to skipping duration as illustrated in FIG. 2.

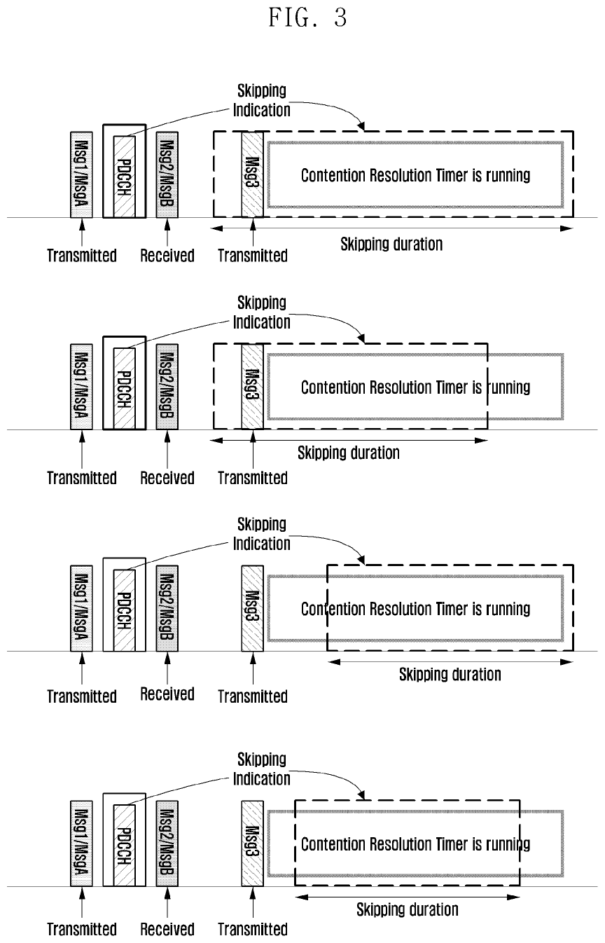

FIG. 3 discloses an example of an Msg4 reception associated with a PDCCH skipping according to an embodiment of the disclosure.

Referring to FIG. 3, in another scenario, RA is triggered and Msg1/MsgA is transmitted; the UE receives RAR/fallbackRAR; the UE transmits Msg3 and starts contention resolution timer. Contention resolution timer duration overlaps with PDCCH skipping duration indicated by PDCCH skipping indication (PDCCH skipping indication can be received during/before RA procedure). Msg4 reception or retransmission resource for Msg3 can be missed or delayed due to skipping duration as shown in FIG. 3.

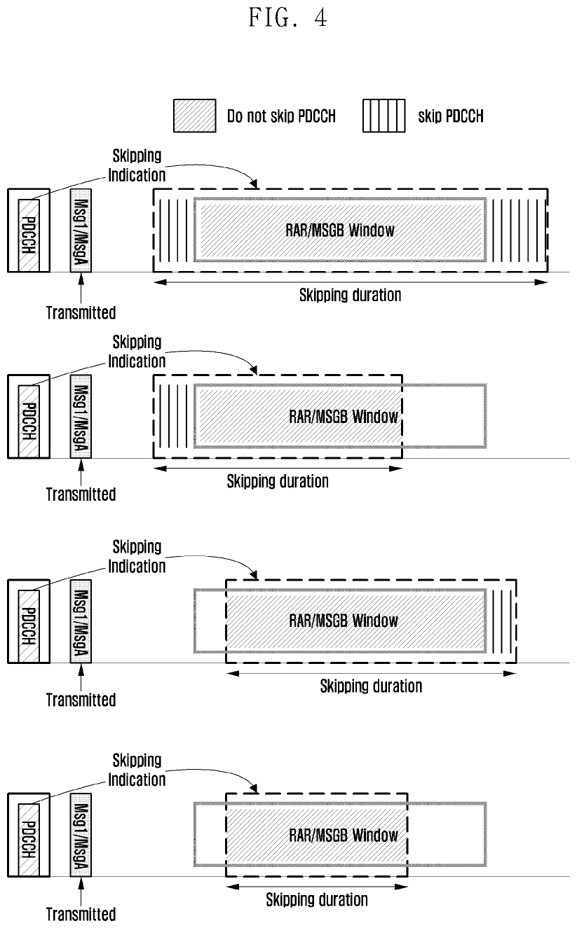

FIG. 4 discloses an embodiment of the disclosure for a random access procedure associated with a PDCCH skipping according to an embodiment of the disclosure.

FIG. 5 discloses another embodiment of the disclosure for a random access procedure associated with an PDCCH skipping according to an embodiment of the disclosure.

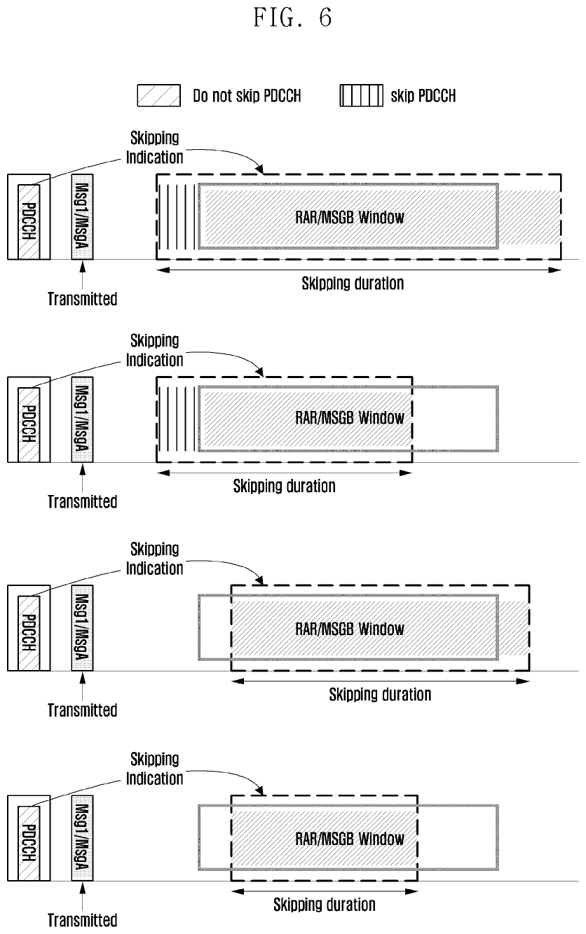

FIG. 6 discloses another embodiment of the disclosure for a random access procedure associated with a PDCCH skipping according to an embodiment of the disclosure.

### Method 1

Referring to FIGS. 4-6, the UE is in RRC_CONNECTED state.

The UE monitors PDCCH in the active DL BWP of SpCell and active DL BWP(s) of activated Secondary cell(s). The PDCCH is monitored in PDCCH monitoring occasions configured by one or more search space configurations of active DL BWP.

The UE receives PDCCH from a gNBwherein the DCI includes/indicates PDCCH skipping. In an embodiment, in the RRC_CONNECTED state, the UE may indicate to the gNB using dedicated RRC message whether it supports PDCCH skipping. In an embodiment, if the gNB has received indication from the UE that it supports PDCCH skipping, the gNB sends PDCCH skipping indication in DCI.

In the RRC_CONNECTED state, the UE initiates random access procedure. The initiated random access procedure can be a 2 step RA procedure or a 4 step RA procedure as explained earlier. The random access procedure can be initiated for beam failure recovery of SpCell/SCell or for beam failure recovery of TRP of serving cell or for scheduling request or for consistent LBT failure recovery, etc. During the random access procedure, the UE starts ra-ContentionResolutionTimer or msgB-ResponseWindow or rar-ResponseWindow as explained earlier (e.g. In case the random access procedure is a 4 step RA procedure, UE transmits Msg1 (i.e. RA preamble) in the PRACH occasion and then starts rar-ResponseWindow for receiving RAR. If RAR is received, UE transmits Msg3 in the PUSCH resource indicated by UL grant received in RAR and starts the ra-ContentionResolutionTimer upon transmitting the Msg3. In case the random access procedure is a 2 step RA procedure, UE transmits MsgA (i.e. RA preamble in the PRACH occasion and MsgA MAC PDU in the PUSCH occasion) and then starts msgB-ResponseWindow for receiving MsgB. If MsgB is received and includes fallback indication, UE transmits Msg3 in the PUSCH resource indicated by UL grant received in MsgB and starts the ra-ContentionResolutionTimer upon transmitting the Msg3).

In this method of this disclosure, if ra-ContentionResolutionTimer or msgB-ResponseWindow or rar-ResponseWindow is running at the time when the PDCCH skipping indication is received; or if ra-ContentionResolutionTimer or msgB-ResponseWindow or rar-ResponseWindow is running during the PDCCH skipping duration (PDCCH skipping indication may be received before or after the random access procedure is initiated or PDCCH skipping indication may be received before or after the ra-ContentionResolutionTimer or msgB-ResponseWindow or rar-ResponseWindow is started), the UE performs the following operation:

Option 1: The UE cancels or suspends or ignores PDCCH skipping on all serving cells of CG during the part of PDCCH skipping duration which overlaps with ra-ContentionResolutionTimer/msgB-ResponseWindow/rar-ResponseWindow. FIG. 4 illustrates the operation performed by UE for all serving cells of CG in case of overlapping between PDCCH skipping duration and msgB-ResponseWindow/rar-ResponseWindow. The portion/part may be the complete PDCCH skipping duration. The portion/part of PDCCH skipping duration which does not overlaps with ra-ContentionResolutionTimer/msgB-ResponseWindow/rar-ResponseWindow, UE/gNB does not cancels or suspends or ignores PDCCH skipping. Here CG is the cell group of the cell for which random access procedure is initiated. It is to be noted that PDCCH skipping duration can be different in different cells of CG, PDCCH skipping duration of zero or more cells of CG can occur during ra-ContentionResolutionTimer/msgB-ResponseWindow/rar-ResponseWindow is running, so ‘PDCCH skipping is cancelled or suspended or ignored by UE on all serving cells of the CG’ may mean PDCCH skipping is cancelled or suspended or ignored by UE on those serving cell(s) of the CG for which skipping duration (as indicated by skipping indication) occurs while the ra-ContentionResolutionTimer/msgB-ResponseWindow/rar-ResponseWindow is running.

Option 2: The UE cancels or suspends or ignores PDCCH skipping on all serving cells of CG during the PDCCH skipping duration. FIG. 5 illustrates the operation performed by UE for all serving cells of CG in case of overlapping between PDCCH skipping duration and msgB-ResponseWindow/rar-ResponseWindow. Here CG is the cell group of the cell for which random access procedure is initiated. It is to be noted that PDCCH skipping duration can be different in different cells of CG, PDCCH skipping duration of zero or more cells of CG can occur during ra-ContentionResolutionTimer/msgB-ResponseWindow/rar-ResponseWindow is running, so ‘PDCCH skipping is cancelled or suspended or ignored by UE on all serving cells of the CG’ may mean PDCCH skipping is cancelled or suspended or ignored by UE on those serving cell(s) of the CG for which skipping duration (as indicated by skipping indication) occurs while the ra-ContentionResolutionTimer/msgB-ResponseWindow/rar-ResponseWindow is running.

Option 3: The UE cancels or suspends or ignores PDCCH skipping on all serving cells of CG from the start of overlapping between the PDCCH skipping duration and ra-ContentionResolutionTimer/msgB-ResponseWindow/rar-ResponseWindow, until the end of PDCCH skipping duration. FIG. 6 illustrates the operation performed by UE for all serving cells of CG in case of overlapping between PDCCH skipping duration and msgB-ResponseWindow/rar-ResponseWindow. Here CG is the cell group of the cell for which random access procedure is initiated.

Option 4: The UE cancels or suspends or ignores PDCCH skipping on SpCell during the part of PDCCH skipping duration which overlaps with ra-ContentionResolutionTimer/msgB-ResponseWindow/rar-ResponseWindow and skip PDCCH monitoring on other serving cells (i.e. serving cells other than SpCell) of CG during the PDCCH skipping duration. The portion/part may be the complete PDCCH skipping duration. Here CG is the cell group of the cell for which random access procedure is initiated. This is illustrated in FIG. 4 for overlapping between PDCCH skipping duration and msgB-ResponseWindow/rar-ResponseWindow on the SpCell. It is to be noted that PDCCH skipping duration can be different in different cells of CG, PDCCH skipping duration of zero or more cells of CG can occur during ra-ContentionResolutionTimer/msgB-ResponseWindow/rar-ResponseWindow is running, so ‘PDCCH skipping is cancelled or suspended or ignored by UE on other serving cells of the CG’ may mean PDCCH skipping is cancelled or suspended or ignored by UE on those other serving cell(s) of the CG for which skipping duration (as indicated by skipping indication) occurs while the ra-ContentionResolutionTimer/msgB-ResponseWindow/rar-ResponseWindow is running.

Option 5: The UE cancels or suspends or ignores PDCCH skipping on SpCell during the PDCCH skipping duration and skip PDCCH monitoring on other serving cells of CG during the skipping duration. Here CG is the cell group of the cell for which random access procedure is initiated. This is illustrated in FIG. 5 for overlapping between PDCCH skipping duration and msgB-ResponseWindow/rar-ResponseWindow on the SpCell.

Option 6: The UE cancels or suspends or ignores PDCCH skipping on SpCell from the start of overlapping between the PDCCH skipping duration and ra-ContentionResolutionTimer/msgB-ResponseWindow/rar-ResponseWindow, until the end of PDCCH skipping duration and skip PDCCH monitoring on other serving cells of CG during the skipping duration. This is illustrated in FIG. 6 for overlapping between PDCCH skipping duration and msgB-ResponseWindow/rar-ResponseWindow on the SpCell. Here CG is the cell group of the cell for which random access procedure is initiated. It is to be noted that PDCCH skipping duration can be different in different cells of CG, PDCCH skipping duration of zero or more cells of CG can occur during ra-ContentionResolutionTimer/msgB-ResponseWindow/rar-ResponseWindow is running, so ‘PDCCH skipping is cancelled or suspended or ignored by UE on other serving cells of the CG’ may mean PDCCH skipping is cancelled or suspended or ignored by UE on those other serving cell(s) of the CG for which skipping duration (as indicated by skipping indication) occurs while the ra-ContentionResolutionTimer/msgB-ResponseWindow/rar-ResponseWindow is running.

In an embodiment, in the above description, PDCCH indicating the UE to switch to an empty SSSG (i.e., SSSG not configured with any search space sets) or default SSSG is also considered as PDCCH skipping indication. Skipping duration can be defined by a timer in this case or it can be the time duration until the UE receives PDCCH indicating the UE to switch to a non-empty SSSG or non-default SSSG.

In an embodiment, the above operation can also be applied in RRC_INACTIVE and/or RRC_IDLE, for example the UE may receive the PDCCH skipping indication during the small data transmission procedure in RRC_INACTIVE and RA can be triggered and transmitted in RRC_INACTIVE state. The PDCCH skipping indication can be indicated in wakeup signal or early paging indication or in RAR or MsgB in RRC_INACTIVE and/or RRC_IDLE. In an embodiment, for small data transmission procedure in RRC_INACTIVE or in RRC_IDLE state, if RA is initiated for SDT (small data transmission), PDCCH skipping indication can be sent by the gNB in between Msg4 (including contention resolution identity MAC CE) transmission or MsgB including contention resolution identity transmission and RRC Release message transmission. In an embodiment, for small data transmission procedure in RRC_INACTIVE state or in RRC_IDLE state, if RA is initiated for SDT, PDCCH skipping indication can be sent by the gNB after the successful completion of random access procedure.

### Method 2

The UE is in RRC_CONNECTED state.

The UE monitors PDCCH in the active DL BWP of SpCell and active DL BWP(s) of activated Secondary cell(s). The PDCCH is monitored in PDCCH monitoring occasions configured by one or more search space configurations of active DL BWP.

The UE receives PDCCH from a gNB wherein the DCI includes/indicates PDCCH skipping. In an embodiment, in the RRC_CONNECTED state, UE may indicate to the gNB using dedicated RRC message whether it supports PDCCH skipping. In an embodiment, if the gNB has received indication from the UE that it supports PDCCH skipping, the gNB sends PDCCH skipping indication in DCI.

In the RRC_CONNECTED state, the UE initiates the random access procedure. The initiated random access procedure can be a 2 step RA procedure or a 4 step RA procedure as explained earlier. The random access procedure can be initiated for beam failure recovery of SpCell/SCell or for beam failure recovery of TRP of serving cell or for scheduling request or for consistent LBT failure recovery, etc. During the random access procedure, the UE starts ra-ContentionResolutionTimer or msgB-ResponseWindow or rar-ResponseWindow as explained earlier (e.g. in case the random access procedure is a 4 step RA procedure, UE transmits Msg1 (i.e. RA preamble) in the PRACH occasion and then starts rar-ResponseWindow for receiving RAR. If RAR is received, UE transmits Msg3 in the PUSCH resource indicated by UL grant received in RAR and starts the ra-ContentionResolutionTimer upon transmitting the Msg3. In case the random access procedure is a 2 step RA procedure, UE transmits MsgA (i.e. RA preamble in the PRACH occasion and MsgA MAC PDU in the PUSCH occasion) and then starts msgB-ResponseWindow for receiving MsgB. If MsgB is received and includes fallback indication, UE transmits Msg3 in the PUSCH resource indicated by UL grant received in MsgB and starts the ra-ContentionResolutionTimer upon transmitting the Msg3).

In this method of this disclosure, if ra-ContentionResolutionTimer or msgB-ResponseWindow or rar-ResponseWindow is running at the time when the PDCCH skipping indication is received; or if ra-ContentionResolutionTimer or msgB-ResponseWindow or rar-ResponseWindow is running during the PDCCH skipping duration (PDCCH skipping indication may be received before or after the random access procedure is initiated or PDCCH skipping indication may be received before or after the ra-ContentionResolutionTimer or msgB-ResponseWindow or rar-ResponseWindow is started), the UE performs the following operation (note that here it is assumed that PDCCH skipping indication is cell specific, if PDCCH skipping indication is received for a serving cell of a CG, PDCCH skipping is applied during the PDCCH skipping duration for that serving cell):

Option 1: The UE cancels or suspends or ignores PDCCH skipping for SpCell during the part of PDCCH skipping duration which overlaps with ra-ContentionResolutionTimer/msgB-ResponseWindow/rar-ResponseWindow. This is illustrated in FIG. 4 for overlapping between PDCCH skipping duration and msgB-ResponseWindow/rar-ResponseWindow on the SpCell. The portion/part may be the complete PDCCH skipping duration. In case random access is initiated for a serving cell of MCG, SpCell is the PCell. In case random access is initiated for a serving cell of SCG, SpCell is the PSCell.

Option 2: The UE cancels or suspends or ignores PDCCH skipping for SpCell during the PDCCH skipping duration. This is illustrated in FIG. 5 for overlapping between PDCCH skipping duration and msgB-ResponseWindow/rar-ResponseWindow on the SpCell. In case random access is initiated for a serving cell of MCG, SpCell is the PCell. In case random access is initiated for a serving cell of SCG, SpCell is the PSCell.

Option 3: The UE cancels or suspends or ignores PDCCH skipping for SpCell from the start of overlapping between the PDCCH skipping duration and ra-ContentionResolutionTimer/msgB-ResponseWindow/rar-ResponseWindow, until the end of PDCCH skipping duration. This is illustrated in FIG. 6 for overlapping between PDCCH skipping duration and msgB-ResponseWindow/rar-ResponseWindow on the SpCell. In case random access is initiated for a serving cell of MCG, SpCell is the PCell. In case random access is initiated for a serving cell of SCG, SpCell is the PSCell

In an embodiment, in the above description, PDCCH indicating the UE to switch to an empty SSSG (i.e., SSSG not configured with any search space sets) or default SSSG is also considered as PDCCH skipping indication. Skipping duration can be defined by a timer in this case or it can be the time duration until the UE receives PDCCH indicating the UE to switch to a non-empty SSSG or non-default SSSG.

In an embodiment, the above operation can also be applied in RRC_INACTIVE and/or RRC_IDLE, for example, the UE may receive the PDCCH skipping indication during the small data transmission procedure in RRC_INACTIVE and RA can be triggered and transmitted in RRC_INACTIVE state. The PDCCH skipping indication can be indicated in wakeup signal or early paging indication or in RAR or MsgB in RRC_INACTIVE and/or RRC_IDLE. In an embodiment, for small data transmission procedure in RRC_INACTIVE or in RRC_IDLE state, if RA is initiated for SDT, PDCCH skipping indication can be sent by the gNB in between Msg4 (including contention resolution identity MAC CE) transmission or MsgB including contention resolution identity transmission and RRC Release message transmission. In an embodiment, for small data transmission procedure in RRC_INACTIVE state or in RRC_IDLE state, if RA is initiated for SDT, PDCCH skipping indication can be sent by the gNB after the successful completion of random access procedure.

### Method 3

The UE is in RRC_CONNECTED state.

The UE monitors PDCCH in the active DL BWP of SpCell and active DL BWP(s) of activated Secondary cell(s). The PDCCH is monitored in PDCCH monitoring occasions configured by one or more search space configurations of active DL BWP.

The UE receives PDCCH from a serving cell wherein the DCI includes/indicates PDCCH skipping. In an embodiment, in the RRC_CONNECTED state, the UE may indicate to the gNB using dedicated RRC message whether it supports PDCCH skipping. In an embodiment, if the gNB has received indication from the UE that it supports PDCCH skipping, the gNB sends PDCCH skipping indication in DCI.

In the RRC_CONNECTED state, the UE initiates the random access procedure. The random access procedure can be initiated for beam failure recovery of SpCell/SCell or for beam failure recovery of TRP of serving cell or for scheduling request, or for consistent LBT failure recovery, etc. During the random access procedure, the UE starts ra-ContentionResolutionTimer or msgB-ResponseWindow or rar-ResponseWindow as explained earlier (e.g. in case the random access procedure is a 4 step RA procedure, UE transmits Msg1 (i.e. RA preamble) in the PRACH occasion and then starts rar-ResponseWindow for receiving RAR. If RAR is received, UE transmits Msg3 in the PUSCH resource indicated by UL grant received in RAR and starts the ra-ContentionResolutionTimer upon transmitting the Msg3. In case the random access procedure is a 2 step RA procedure, UE transmits MsgA (i.e. RA preamble in the PRACH occasion and MsgA MAC PDU in the PUSCH occasion) and then starts msgB-ResponseWindow for receiving MsgB. If MsgB is received and includes fallback indication, UE transmits Msg3 in the PUSCH resource indicated by UL grant received in MsgB and starts the ra-ContentionResolutionTimer upon transmitting the Msg3).

In this method of this disclosure, if ra-ContentionResolutionTimer or msgB-ResponseWindow or rar-ResponseWindow is running at the time when the PDCCH skipping indication is received; or if ra-ContentionResolutionTimer or msgB-ResponseWindow or rar-ResponseWindow is running during the PDCCH skipping duration (PDCCH skipping indication may be received before or after the random access procedure is initiated or PDCCH skipping indication may be received before or after the ra-ContentionResolutionTimer or msgB-ResponseWindow or rar-ResponseWindow is started), the UE performs the following operation (note that here it is assumed that PDCCH skipping indication is DRX group specific, if PDCCH skipping indication is received for a DRX group of a CG, PDCCH skipping is applied during the PDCCH skipping duration for all serving cells of that DRX group):

Option 1: The UE cancels or suspends or ignores PDCCH skipping on all serving cells of non-secondary DRX group during the part of PDCCH skipping duration which overlaps with ra-ContentionResolutionTimer/msgB-ResponseWindow/rar-ResponseWindow. This is illustrated in FIG. 4 for overlapping between PDCCH skipping duration and msgB-ResponseWindow/rar-ResponseWindow on all serving cells of non-secondary DRX group. Here non-secondary DRX group and secondary DRX group refers to DRX groups of CG for which random access procedure is initiated.

Option 2: The UE cancels or suspends or ignores PDCCH skipping on all serving cells of non-secondary DRX group during the PDCCH skipping duration. This is illustrated in FIG. 5 for overlapping between PDCCH skipping duration and msgB-ResponseWindow/rar-ResponseWindow on all serving cells of non-secondary DRX group. Here non-secondary DRX group and secondary DRX group refers to DRX groups of CG for which random access procedure is initiated.

Option 3: The UE cancels or suspends or ignores PDCCH skipping on all serving cells of non-secondary DRX group from the start of overlapping between the PDCCH skipping duration and ra-ContentionResolutionTimer/msgB-ResponseWindow/rar-ResponseWindow, until the end of PDCCH skipping duration. This is illustrated in FIG. 6 for overlapping between PDCCH skipping duration and msgB-ResponseWindow/rar-ResponseWindow on all serving cells of non-secondary DRX group. Here non-secondary DRX group and secondary DRX group refers to DRX groups of CG for which random access procedure is initiated.

Option 4: The UE cancels or suspends or ignores PDCCH skipping on SpCell) during the part of PDCCH skipping duration which overlaps with ra-ContentionResolutionTimer/msgB-ResponseWindow/rar-ResponseWindow and skips PDCCH monitoring on other serving cells of non-secondary DRX group during the skipping duration. This is illustrated in FIG. 4 for overlapping between PDCCH skipping duration and msgB-ResponseWindow/rar-ResponseWindow on the SpCell. Here non-secondary DRX group and secondary DRX group refers to DRX groups of CG for which random access procedure is initiated.

Option 5: The UE cancels or suspends or ignores PDCCH skipping on SpCell) during the PDCCH skipping duration and skips PDCCH monitoring on other serving cells of non-secondary DRX group during the skipping duration. This is illustrated in FIG. 5 for overlapping between PDCCH skipping duration and msgB-ResponseWindow/rar-ResponseWindow on the SpCell. Here non-secondary DRX group and secondary DRX group refers to DRX groups of CG for which random access procedure is initiated.

Option 6: The UE cancels or suspends or ignores PDCCH skipping on SpCell from the start of overlapping between the PDCCH skipping duration and ra-ContentionResolutionTimer/msgB-ResponseWindow/rar-ResponseWindow, until the end of PDCCH skipping duration and skips PDCCH monitoring on other serving cells of non-secondary DRX group during the skipping duration. This is illustrated in FIG. 6 for overlapping between PDCCH skipping duration and msgB-ResponseWindow/rar-ResponseWindow on the SpCell. Here non-secondary DRX group and secondary DRX group refers to DRX groups of CG for which random access procedure is initiated.

In an embodiment, in the above description, PDCCH indicating the UE to switch to an empty SSSG (i.e., SSSG not configured with any search space sets) or default SSSG is also considered as PDCCH skipping indication. Skipping duration can be defined by a timer in this case or it can be the time duration until the UE receives PDCCH indicating the UE to switch to a non-empty SSSG or non-default SSSG.

In an embodiment, the above operation can also be applied in RRC_INACTIVE and/or RRC_IDLE, for example, the UE may receive the PDCCH skipping indication during the small data transmission procedure in RRC_INACTIVE and RA can be triggered and transmitted in RRC_INACTIVE state. The PDCCH skipping indication can be indicated in wakeup signal or early paging indication or in RAR or MsgB in RRC_INACTIVE and/or RRC_IDLE. In an embodiment, for small data transmission procedure in RRC_INACTIVE or in RRC_IDLE state, if RA is initiated for SDT, PDCCH skipping indication can be sent by the gNB in between Msg4 (including contention resolution identity MAC CE) transmission or MsgB including contention resolution identity transmission and RRC Release message transmission. In an embodiment, for small data transmission procedure in RRC_INACTIVE state or in RRC_IDLE state, if RA is initiated for SDT, PDCCH skipping indication can be sent by the gNB after the successful completion of random access procedure.

In an embodiment, the methods 1 to 3 described in this disclosure can be applied in RRC_INACTIVE and/or RRC_IDLE wherein the Msg3/MsgA includes RRC message (e.g. RRC Connection setup request, RRC resume request, System information message request, or any other RRC message).

In methods 1 to 3 described in this disclosure, if PDCCH skipping cancellation is applied during PDCCH skipping duration.

In case of 4 step RA, when skipping cancellation/suspension is due to RAR window (i.e., overlapping between RAR window and skipping duration),

If random access procedure is for beam failure recovery and preamble selected for Msg1 is not selected from contention based preamble, the UE monitors PDCCH addressed to C-RNTI but skips monitoring other PDCCHs (i.e., PDCCHs which the UE skips monitoring during the skipping duration, e.g. PDCCH addressed to CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, RA-RNTI, P-RNTI, SI-RNTI, SL-RNTI), MSGB-RNTI).

If random access procedure is not for beam failure recovery, the UE monitors PDCCH addressed to RA-RNTI but skips monitoring other PDCCHs (i.e., PDCCHs which UE skips monitoring during the skipping duration e.g. PDCCH addressed to C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, P-RNTI, SI-RNTI, SL-RNTI, MSGB-RNTI).

In case of 2 step RA, when skipping cancellation/suspension is due to MsgB window (i.e., overlapping between MsgB window and skipping duration).

If MsgA MAC PDU was transmitted, the UE monitors PDCCH addressed to MsgB-RNTI and C-RNTI but skips monitoring other PDCCHs (i.e., PDCCHs which the UE skips monitoring during the skipping duration e.g. PDCCH addressed to CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, P-RNTI, SI-RNTI, SL-RNTI).

If MsgA MAC PDU was not transmitted, the UE monitors PDCCH addressed to MsgB-RNTI but skips monitoring other PDCCHs (i.e., PDCCHs which the UE skips monitoring during the skipping duration e.g. PDCCH addressed to C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, P-RNTI, SI-RNTI, SL-RNTI).

In case of 2/4 step RA, when cancellation/suspension is due to contention resolution timer, the UE monitors PDCCH addressed to TC-RNTI/C-RNTI but skips monitoring other PDCCHs (i.e., PDCCHs which the UE skips monitoring during the skipping duration e.g. PDCCH addressed to CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, P-RNTI, SI-RNTI, SL-RNTI, MSGB-RNTI, RA-RNTI).

In methods 1 to 3 described in this disclosure, in an embodiment, if criteria (as defined in methods 1 to 3) to cancel/suspend skipping is met, the UE may not apply skipping cancellation/suspension, if skipping duration does not extend until the end of active time during the DRX operation.

In methods 1 to 3 described in this disclosure, in an embodiment, if criteria (as defined in methods 1 to 3) to cancel/suspend skipping is met, the UE may apply skipping cancellation/suspension only for a part/portion of skipping duration wherein the length of part/portion can be pre-defined or signaled by the gNB in RRC/DCl/MAC CE, the unit in which length is specified can be in slots/symbols/subframes/frames/number of PDCCH monitoring occasions.

In methods 1 to 3 described in this disclosure, in an embodiment, if criteria (as defined in methods 1 to 3) to cancel/suspend skipping is met, the UE may apply skipping cancellation/suspension only for first/earliest PDCCH monitoring occasion in the skipping duration.

In methods 1 to 3 described in this disclosure, in an embodiment, if criteria (as defined in methods 1 to 3) to cancel/suspend skipping is met, the UE may apply skipping cancellation/suspension for earliest ‘N’ PDCCH monitoring occasion in the skipping duration, where parameter ‘N’ can be pre-defined or signaled by the gNB in RRC message or system information.

### Random Access and Msg3 Repetition Aspects

In an embodiment of this disclosure, upon initiation of random access procedure, the UE first selects the carrier (SUL or NUL). If the carrier to use for the Random Access procedure is explicitly signaled by the gNB, the UE select the signaled carrier for performing Random Access procedure. If the carrier to use for the Random Access procedure is not explicitly signaled by the gNB; and if the Serving Cell for the Random Access procedure is configured with supplementary uplink and if criteria to request Msg3 PUSCH repetition is met and if random access resources for Msg3 PUSCH repetition is configured only on the supplementary uplink (i.e., not configured on normal uplink), the UE select the SUL carrier for performing Random Access procedure. A UE requests Msg3 PUSCH repetition when the RSRP of the downlink pathloss reference is lower than an RSRP threshold. Note that this threshold is different from threshold used for SUL and NUL carrier selection.

If the carrier to use for the Random Access procedure is not explicitly signaled by the gNB; and if the Serving Cell for the Random Access procedure is configured with supplementary uplink and if criteria to request Msg3 PUSCH repetition is met and if random access resources for Msg3 PUSCH repetition is configured only on the normal uplink (i.e., not configured on supplementary uplink) the UE select the NUL carrier for performing Random Access procedure.

If the carrier to use for the Random Access procedure is not explicitly signaled by the gNB; and if the Serving Cell for the Random Access procedure is configured with supplementary uplink and if criteria to request Msg3 PUSCH repetition is met and if random access resources for Msg3 PUSCH repetition is configured on both normal and supplementary uplink:
if the RSRP of the downlink pathloss reference is less than rsrp-ThresholdSSB-SUL, the UE select the SUL carrier for performing Random Access procedure. Otherwise, the UE select the NUL carrier for performing Random Access procedure

If the carrier to use for the Random Access procedure is not explicitly signaled by the gNB; and if the Serving Cell for the Random Access procedure is configured with supplementary uplink and if criteria to request Msg3 PUSCH repetition is not met and if the RSRP of the downlink pathloss reference is less than rsrp-ThresholdSSB-SUL: the UE select the SUL carrier for performing Random Access procedure. Otherwise, the UE select the NUL carrier for performing Random Access procedure.

Upon selecting the UL carrier, the UE determines the UL and DL BWP for random access. Upon initiation of the Random Access procedure on a Serving Cell, after the selection of carrier for performing Random Access procedure, the MAC entity shall for the selected carrier of this Serving Cell:

1> if criteria to request Msg3 PUSCH repetition is met and if random access resources for requesting Msg3 PUSCH repetition is not configured for the active UL BWP and if random access resources for requesting Msg3 PUSCH repetition is configured for the initial UL BWP:

2> switch the active UL BWP to BWP indicated by initialUplinkBWP;

2> if the Serving Cell is an SpCell:

3> switch the active DL BWP to BWP indicated by initialDownlinkBWP.

1> else:

2> if the Serving Cell is an SpCell:

3> if the active DL BWP does not have the same bwp-Id as the active UL BWP:

4> switch the active DL BWP to the DL BWP with the same bwp-Id as the active UL BWP.

1> perform the Random Access procedure on the active DL BWP of SpCell and active UL BWP of this Serving Cell.

Alternately, upon initiation of the Random Access procedure on a Serving Cell, after the selection of carrier for performing Random Access procedure, the MAC entity shall for the selected carrier of this Serving Cell:

1> if criteria to request Msg3 PUSCH repetition is met and if random access resources for requesting Msg3 PUSCH repetition is not configured for the active UL BWP and if random access resources for requesting Msg3 PUSCH repetition is configured for the another UL BWP:

2> switch the active UL BWP to BWP where random access resources for requesting Msg3 PUSCH repetition is configured;

2> if the Serving Cell is an SpCell:

3> switch the active DL BWP to BWP with same BWP ID as the switched UL BWP.

1> else:

2> if the Serving Cell is an SpCell:

3> if the active DL BWP does not have the same bwp-Id as the active UL BWP:

4> switch the active DL BWP to the DL BWP with the same bwp-Id as the active UL BWP.

1> perform the Random Access procedure on the active DL BWP of SpCell and active UL BWP of this Serving Cell.

UE then determines whether to perform 2 step or 4 step RACH for this random access procedure. Upon initiation of random access procedure, RA type selection can be selected in one of the following ways:

Option 1: RA type selection considering whether RACH configuration for UL coverage is signaled by the gNB or not.

Option 1A: Assumption is that UL coverage enhancement is supported only for 4 step RA.

If criteria to request for Msg3 PUSCH repetition is met and 4 step RACH configuration is provided for UL coverage enhancement (i.e., random access resources for requesting Msg3 PUSCH repetition is configured in BWP, i.e., active UL BWP of selected UL carrier):
UE selects 4 step RA. UE applies 4 step RACH configuration for UL coverage enhancement i.e., 4 step RACH configuration for requesting Msg3 PUSCH repetition.

Else:
UE selects between 2 step RA and 4 step RA as in legacy considering only the RACH configurations which is not configured for UL coverage enhancement.

Option 1B: Assumption is that UL coverage enhancement is supported for both 2 step RA and 4 step RA.

If criteria to request for Msg3 PUSCH repetition is met and 4 step RACH configuration is configured in BWP, i.e., active UL BWP of selected UL carrier) for UL coverage enhancement and 2 step RACH configuration is configured in BWP, i.e., active UL BWP of selected UL carrier) for UL coverage enhancement:
UE selects between 2 step RA and 4 step RA based on RSRP threshold (if RSRP of the downlink pathloss reference is below a configured threshold, the UE selects 4 step RACH. Otherwise, the UE selects 2 step RACH). Apply RACH configuration for UL coverage enhancement (i.e., for Msg3 PUSCH repetition) corresponding to selected RA type.

Else if criteria to request for Msg3 PUSCH repetition is met and only 4 step RACH configuration is configured in BWP i.e., active UL BWP of selected UL carrier) for UL coverage enhancement:
UE selects 4 step RA. Apply 4 step RACH configuration for UL coverage enhancement (i.e., for Msg3 PUSCH repetition).

Else if criteria to request for Msg3 PUSCH repetition is met and only 2 step RACH configuration is configured in BWP, i.e., active UL BWP of selected UL carrier) for UL coverage enhancement:
UE selects 2 step RA. Apply 2 step RACH configuration for UL coverage enhancement (i.e., for Msg3 PUSCH repetition).

Else (i.e., RACH configuration is not provided for UL coverage enhancement):
UE selects between 2 step RA and 4 step RA as in legacy considering only the RACH configurations which is not configured for UL coverage enhancement.

Option 2: RA type selection is independent of whether RACH configuration for UL coverage is signaled by the gNB or not. Here the RACH configuration refers to RACH configuration for UL coverage enhancement (i.e., for Msg3 PUSCH repetition) and/or RACH configuration not configured for UL coverage enhancement (i.e., for Msg3 PUSCH repetition).

If both 4 step RACH configuration and 2 step RACH configuration is configured in BWP, i.e., active UL BWP of selected UL carrier:

UE selects between 2 step RA and 4 step RA based on RSRP threshold (if RSRP of the downlink pathloss reference is below a configured threshold, the UE selects 4 step RACH. Otherwise, the UE selects 2 step RACH).

Else if only 4 step RACH configuration is configured in BWP, i.e., active UL BWP of selected UL carrier:

UE selects 4 step RA.

Else if only 2 step RACH configuration is configured in BWP, i.e., active UL BWP of selected UL carrier:

UE selects 2 step RA.

If criteria to request for Msg3 PUSCH repetition is met and RACH configuration for selected RACH type is configured in BWP (i.e., active UL BWP of selected UL carrier) for UL coverage enhancement:

The UE applies RACH configuration (corresponding to selected RACH type) for UL coverage enhancement (i.e., for Msg3 PUSCH repetition). The UE selects random access resources (preambles/ROs) from the RACH configuration (corresponding to selected RACH type) for UL coverage enhancement (i.e., for Msg3 PUSCH repetition).

Else:

The UE applies RACH configuration (corresponding to selected RACH type) which is not configured for UL coverage enhancement. The UE selects random access resources (preambles/ROs) from the RACH configuration (corresponding to selected RACH type) which is not configured for UL coverage enhancement (i.e., not configured for Msg3 PUSCH repetition).

Selection between 2 step RA and 4 step RA as in legacy:

If this random access procedure is initiated by PDCCH order and if the ra-PreambleIndex explicitly provided by PDCCH is not 0b000000, the UE selects 4 step RACH.
else if 2 step contention free random access resources are signaled by the gNB for this random access procedure, the UE selects 2 step RACH.
else if 4 step contention free random access resources are signaled by the gNB for this random access procedure, the UE selects 4 step RACH.
else if the UL BWP selected for this random access procedure is configured with only 2 step RACH resources, the UE selects 2 step RACH.
else if the UL BWP selected for this random access procedure is configured with only 4 step RACH resources, the UE selects 4 step RACH.
else if the UL BWP selected for this random access procedure is configured with both 2 step and 4 step RACH resources,
if RSRP of the downlink pathloss reference is below a configured threshold, the UE selects 4 step RACH. Otherwise, the UE selects 2 step RACH.

For Msg3 PUSCH repetition using 4 step RACH, following parameters are signalled by the gNB. These parameters can be signaled in rach-ConfigCommonMsg3PUSCHRepetition IE.

startingPreambleIndex4Step-Msg3 PUSCH repetition (S)

ssb-perRACH-Occasion4Step-Msg3 PUSCH repetition (Y)

CB-PreamblesPerSSB4Step-Msg3 PUSCH repetition (X)

If startingPreambleIndex4Step-Msg3 PUSCH repetition is not configured, the UE assumes startingPreambleIndex4Step-Msg3 PUSCH repetition is zero. If ssb-perRACH-Occasion4Step-Msg3 PUSCH repetition is not configured, the value of ssb-perRACH-Occasion4Step-Msg3 PUSCH repetition is equal to ssb-perRACH-Occasion configured for 4 step RACH, i.e., in rach-ConfigCommon. If CB-PreamblesPerSSB4Step-Msg3 PUSCH repetition is not configured, the value of CB-PreamblesPerSSB4Step-Msg3 PUSCH repetition is equal to CB-PreamblesPerSSB configured for 4 step RACH, i.e., in rach-ConfigCommon.

The UE determines preambles for each SSB as follows:

If Y<1: Preambles starting from S to ‘S+X−1’ are used for requesting Msg3 PUSCH repetition. In other words, X contention based preambles with consecutive indexes associated with the SSB per valid PRACH occasion start from S.

If Y>=1, X contention based preambles with consecutive indexes associated with SS/PBCH block n, 0≤n≤Y−1, per valid PRACH occasion start from preamble index ‘S+n·N_{preamble}^{total}/Y, where N_{preamble}^{total} is provided by totalNumberOfRA-Preambles-Msg3 PUSCH repetition. If totalNumberOfRA-Preambles-Msg3 PUSCH repetition is not configured, totalNumberOfRA-Preambles is used.

During the random access procedure for Msg3 PUSCH repetition, the UE will select SSB (as specified in TS 38.321) and then preamble and RO corresponding to selected SSB wherein preamble is selected from set of preambles and set of ROs determined above. The UE then transmit selected PRACH preamble and selected RO.

For Msg3 PUSCH repetition using 2 step RACH, following parameters are signaled by the gNB. These parameters can be signaled in rach-ConfigCommon2Step-Msg3 PUSCH repetition IE or in rach-ConfigCommon2Step IE.

startingPreambleIndex2Step-Msg3 PUSCH repetition (S)

ssb-perRACH-Occasion2Step-Msg3 PUSCH repetition (Y)

CB-PreamblesPerSSB2Step-Msg3 PUSCH repetition (X)

If startingPreambleIndex2Step-Msg3 PUSCH repetition is not configured, the UE assumes startingPreambleIndex2Step-Msg3 PUSCH repetition is zero. If ssb-perRACH-Occasion2Step-Msg3 PUSCH repetition is not configured:

the value of ssb-perRACH-Occasion4Step-Msg3 PUSCH repetition is equal to ssb-perRACH-Occasion2step configured for 2 step RACH, i.e., in rach-ConfigCommon2Step; the value of ssb-perRACH-Occasion4Step-Msg3 PUSCH repetition is equal to ssb-perRACH-Occasion configured for 4 step RACH, i.e., in rach-ConfigCommon if ssb-perRACH-Occasion2step is not configured.

If CB-PreamblesPerSSB2Step-Msg3 PUSCH repetition is not configured, the value of CB-PreamblesPerSSB2Step-Msg3 PUSCH repetition is equal to CB-PreamblesPerSSB2Step configured for 2 step RACH, i.e., in rach-ConfigCommon2Step; the value of CB-PreamblesPerSSB2Step-Msg3 PUSCH repetition is equal to CB-PreamblesPerSSB configured for 4 step RACH, i.e., in rach-ConfigCommon if CB-PreamblesPerSSB2Step is not configured.

UE determines preambles for each SSB as follows:

If Y<1: Preambles starting from S to ‘S+X−1’ are used for Msg3 PUSCH repetition. In other words, X contention based preambles with consecutive indexes associated with the SSB per valid PRACH occasion start from S.

If Y>=1, X contention based preambles with consecutive indexes associated with SS/PBCH block n, 0≤n≤Y−1, per valid PRACH occasion start from preamble index ‘S+n·N_{preamble}^{total}/Y, where N_{preamble}^{total} is provided by totalNumberOfRA-Preambles-2step-Msg3 PUSCH repetition. If totalNumberOfRA-Preambles-2step-Msg3 PUSCH repetition is not configured, totalNumberOfRA-2step-Preambles is used. If totalNumberOfRA-2step-Preambles is not configured totalNumberOfRA-Preambles is used.

In an embodiment, if the UE receives UL grant in RAR during 4 step RA procedure or the UE receives UL grant in fallback RAR during the 2 step RA procedure and UL grant includes repetitions (i.e., multiple transmission occasions for transmitting Msg3 TB), the UE starts the ra-ContentionResolutionTimer in one of the following ways:

Option 1: starting the ra-ContentionResolutionTimer in the first symbol after the end of Msg3 transmission (or HARQ (re) transmission of Msg3) in 1st transmission occasion of UL grant with repetition.

Option 2: starting the ra-ContentionResolutionTimer in the first symbol after the end of Msg3 transmission (or HARQ (re) transmission of Msg3) in last transmission occasion of UL grant with repetition.

Option 3: (re-)starting the ra-ContentionResolutionTimer in the first symbol after the end of Msg3 (or HARQ (re) transmission of Msg3) transmission in every transmission occasion of UL grant with repetition.

The above operation is also performed when the UE receives UL grant for Msg3 in PDCCH addressed to TC-RNTI, where UL grant includes repetitions.

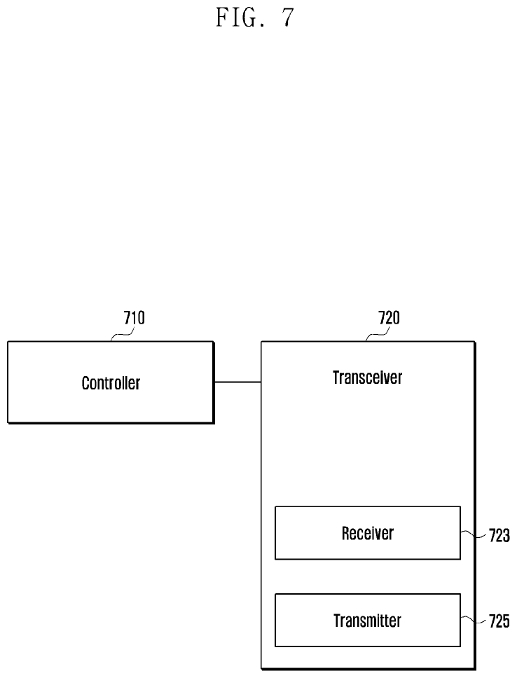

FIG. 7 is a diagram illustrating a configuration of a terminal according to an embodiment of the disclosure.

Referring to FIG. 7, the terminal user equipment (UE) according to an embodiment of the disclosure may include a transceiver 720 and a controller 710 that controls the overall operation of the terminal. The transceiver 720 may include a transmitter 721 and a receiver 723.

The transceiver 720 may transmit and receive signals to and from other network entities.

The controller 710 may control the terminal to perform one operation in the above-described embodiments. Meanwhile, the controller 710 and the transceiver 720 do not have to be implemented as separated modules but may be implemented as one element such as a single chip. The controller 710 and the transceiver 720 may be electrically connected. For example, the controller 710 may be a circuit, an application-specific circuit, or at least one processor. Further, the operations of the terminal may be performed by including a memory device storing a corresponding program code in a predetermined element within the terminal.

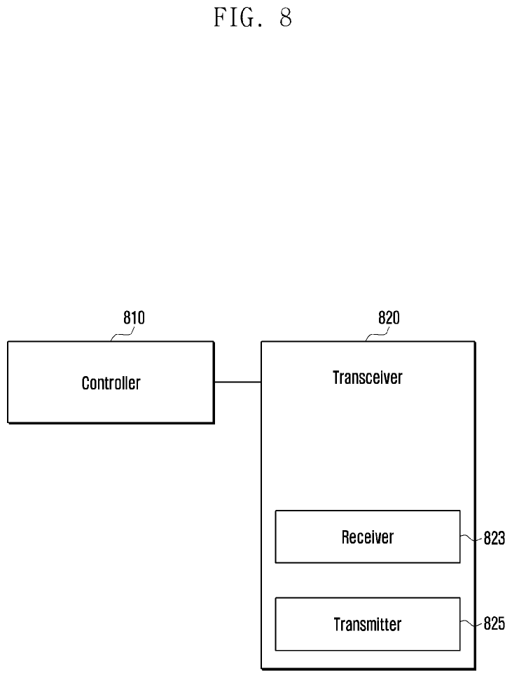

FIG. 8 is a diagram illustrating a configuration of a base station according to an embodiment of the disclosure.

Referring to FIG. 7, the base station according to an embodiment of the disclosure may include a transceiver 820 and a controller 810 that controls the overall operation of the base station. The transceiver 820 may include a transmitter 821 and a receiver 823.

The transceiver 820 may transmit and receive signals to and from network entities and the terminal.

The controller 810 may control the base station to perform one operation in the above-described embodiments. Meanwhile, the controller 810 and the transceiver 820 do not have be implemented as separated modules but may be implemented as one element such as a single chip. The controller 810 and the transceiver 820 may be electrically connected. For example, the controller 810 may be a circuit, an application-specific circuit, or at least one processor. Further, the operations of the base station may be performed by including a memory device storing a corresponding program code in a predetermined element within the base station.

It should be noted that the block diagrams, example diagrams of a control/data signal transmission method, example diagrams of an operation procedure, and diagrams illustrated in FIGS. 1 to 8 have no intent to limit the scope of the disclosure. That is, it should not be construed that all element parts, entities, or operations shown in FIGS. 1 to 8 are essential elements for implementing the disclosure, and it should be understood that only a few elements may implement the disclosure within the scope without departing the subject matter of the disclosure.

The operations of the base station or the UE may be performed when a predetermined element within the base station or the UE apparatus includes a memory device storing the corresponding program code. That is, the controller of the base station or the UE apparatus may perform the operations by reading and executing the program code stored in the memory device through a processor or a Central Processing Unit (CPU).

Various elements and modules of the entity, the base station, or the UE used in the specification may operate by using a hardware circuit, for example, a combination of a complementary metal oxide semiconductor-based logical circuit, firmware, software and/or hardware, or a combination of firmware and/or software inserted into a machine-readable medium. For example, various electrical structures and methods may be performed using transistors, logic gates, and electrical circuits such as application specific integrated circuit.

Although specific embodiments have been described in the detailed description of the disclosure, various modifications and changes may be made thereto without departing from the scope of the disclosure. Therefore, the scope of the disclosure should not be defined as being limited to the embodiments, but should be defined by the appended claims and equivalents thereof.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station, an indication for indicating a skipping of monitoring a physical downlink control channel (PDCCH);
transmitting, to the base station, a random access preamble; and
in case that at least a part of a duration of the skipping of monitoring the PDCCH overlaps with at least a part of a duration for receiving a random access response corresponding to the random access preamble, ignoring PDCCH skipping during the at least the part of the duration of the skipping of monitoring the PDCCH.

2. The method of claim 1, wherein the ignoring the PDCCH is performed on a special cell (SpCell).

3. The method of claim 1, wherein the indication for indicating the skipping of monitoring the PDCCH is received from the base station for a special cell (SpCell).

4. The method of claim 1, wherein the duration for receiving the random access response corresponding to the random access preamble comprises random access response window.

5. The method of claim 1, further comprising:
in case that at least a part of the duration of the skipping of monitoring the PDCCH overlaps with at least a part of a duration associated with a contention resolution timer, ignoring PDCCH skipping during the at least the part of the duration of the skipping of monitoring the PDCCH.

6. The method of claim 5, further comprising:
receiving, from the base station, the random access response;
transmitting, to the base station, a message 3 as a response to the random access response; and
starting the contention resolution timer.

7. The method of claim 1, wherein the indication is received in downlink control information.

8. The method of claim 1, further comprising:
receiving, from the base station, information on a duration of the skipping of monitoring the PDCCH.

9. A terminal in a wireless communication system, the terminal comprising:
a transceiver; and
a controller coupled with the transceiver and configured to:
receive, from a base station, an indication for indicating a skipping of monitoring a physical downlink control channel (PDCCH),
transmit, to the base station, a random access preamble, and
in case that at least a part of a duration of the skipping of monitoring the PDCCH overlaps with at least a part of a duration for receiving a random access response corresponding to the random access preamble, ignoring PDCCH skipping during the at least the part of the duration of the skipping of monitoring the PDCCH.

10. The terminal of claim 9, wherein the ignoring the PDCCH skipping is performed on a special cell (SpCell).

11. The terminal of claim 9, wherein the indication for indicating the skipping of monitoring the PDCCH is received from the base station for a special cell (SpCell).

12. The terminal of claim 9, wherein the duration for receiving the random access response corresponding to the random access preamble comprises a random access response window.

13. The terminal of claim 9, wherein the controller is configured to:
in case that at least a part of the duration of the skipping of monitoring the PDCCH overlaps with at least a part of a duration associated with a contention resolution timer, ignoring the PDCCH skipping during the at least the part of the duration of the skipping of monitoring the PDCCH.

14. The terminal of claim 13, wherein the controller is configured to:
receive, from the base station, the random access response,
transmit, to the base station, a message 3 as a response to the random access response, and
start the contention resolution timer.

15. The terminal of claim 9, wherein the indication is received in downlink control information.

16. The terminal of claim 9, wherein the controller is configured to:
receive, from the base station, information on a duration of the skipping of monitoring the PDCCH.
